(19) United States
(12) Patent Application Publication
(10) Pub. No.: US 2026/0271169 A1
(43) Pub. Date: Sep. 10, 2026

(54) ELECTRIC FIELD INDUCED LIQUID JET BREAKUP INTO A CHAIN OF DROPLETS

(71) Applicant: KLA Corporation, Milpitas, CA (US)

(72) Inventor: Anton Tkachev, San Jose, CA (US)

(21) Appl. No.: 19/555,811

(22) Filed: Mar. 3, 2026

Related U.S. Application Data
(60) Provisional application No. 63/767,692, filed on Mar. 6, 2025.

(51) Int. Cl. H05G 2/00

(52) U.S. Cl. CPC H05G 2/0023

(57) ABSTRACT

A liquid is directed through a nozzle and dispensed as a jet of the liquid. The jet is then directed into an electric field to form a chain of droplets. An electrode is positioned a distance from the jet of the liquid. The electrode is electrically connected with a waveform generator and generates the electric field. The liquid may be xenon or other materials.

### CROSS-REFERENCE TO RELATED APPLICATIONS

This application claims priority to the provisional patent application filed Mar. 6, 2025 and assigned U.S. App. No. 63/767,692, the disclosure of which is hereby incorporated by reference.

### FIELD OF THE DISCLOSURE

This disclosure relates to liquid supply for extreme ultraviolet (EUV) sources.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it maximizes the return-on-investment for a semiconductor manufacturer.

Fabricating semiconductor devices, such as logic and memory devices, typically includes processing a workpiece, such as a semiconductor wafer, using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etching, deposition, and ion implantation. An arrangement of multiple semiconductor devices fabricated on a single semiconductor wafer may be separated into individual semiconductor devices.

Inspection processes are used at various steps during semiconductor manufacturing to detect defects on workpieces to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

As design rules shrink, however, semiconductor manufacturing processes may be operating closer to the limitation on the performance capability of the processes. In addition, smaller defects can have an impact on the electrical parameters of the device as the design rules shrink, which drives more sensitive inspections. As design rules shrink, the population of potentially yield-relevant defects detected by inspection grows dramatically, and the population of nuisance defects detected by inspection also increases dramatically. Therefore, more defects may be detected on the workpieces, and correcting the processes to eliminate all of the defects may be difficult and expensive. Determining which of the defects actually have an effect on the electrical parameters of the devices and the yield may allow process control methods to be focused on those defects while largely ignoring others. Furthermore, at smaller design rules, process-induced failures, in some cases, tend to be systematic. That is, process-induced failures tend to fail at predetermined design patterns often repeated many times within the design. Elimination of spatially-systematic, electrically-relevant defects can have an impact on yield.

Semiconductor inspection systems increasingly rely on EUV radiation to detect sub-nanometer defects on advanced photomasks, workpieces like semiconductor wafers, and other structures that cannot be adequately characterized using longer-wavelength optical methods. Xenon-based EUV plasma sources have been adopted for these metrology and inspection applications because xenon plasmas can generate radiation near the 13.5 nm band with sufficient brightness and stability to support actinic inspection, mask defect detection, and resist characterization. Xenon-driven EUV sources are used in next-generation inspection tools, which generally use high brightness and narrow bandwidth emission to resolve increasingly complex nanoscale defects.

To supply an appropriate plasma target for EUV emission, xenon is often delivered in liquid-jet or droplet form, generated by converting xenon gas into liquid under high-pressure, cryogenic conditions and emitting the liquefied xenon through a nozzle. The resulting micro-jet or droplet stream is then irradiated by a high-power laser to produce a plasma that emits EUV radiation suitable for semiconductor inspection. Liquid xenon's properties provide stability, brightness, and spectral purity used in inspection tools for applications that need strict control of wavelength, radiance, and uptime.

Precise droplet control may be important to ensure stable EUV plasma performance in semiconductor inspection applications because the droplet's mass, size, velocity, and positional repeatability directly affect plasma formation and, consequently, the stability and brightness of the emitted EUV radiation. Droplets were previously formed using a droplet-on-demand system or with piezo-transducer vibration induced jet breakup. The droplet-on-demand technique usually provides a relatively limited range of droplet velocities on the order of 1 m/s or even smaller. A piezo-transducer action is generally design-dependent and may be difficult to predict. A piezo transducer also can excite unwanted vibration modes in the body of the nozzle, which can undermine the liquid jet stability at certain frequencies. Unwanted higher harmonics can be generated within the material and affect best stability and performance of the liquid jet. A piezo transducer also generates heat which at higher frequencies can disrupt liquid phase of xenon.

Therefore, improved systems and techniques are needed.

### BRIEF SUMMARY OF THE DISCLOSURE

A system is provided in a first embodiment. The system includes a liquid source that includes a liquid; a nozzle in liquid communication with the liquid source; a waveform generator; and an electrode positioned a distance from the jet of the liquid. The nozzle is configured to dispense a jet of the liquid. The electrode is electrically connected with the waveform generator. The electrode is configured to generate an electric field that the jet enters to form a chain of droplets. The liquid may be Xe, Sn, Li, Ar, or H₂O. In an instance, the liquid is liquid Xe.

The electrode may be a knife edge electrode, a needle electrode, or an annular electrode that defines an aperture through which the chain of droplets passes.

The distance may be from 10 μm to 1 mm. In an embodiment, the distance is approximately 100 μm.

The electric field may have a field strength from 1 kV/cm to 100 kV/cm.

In an embodiment, a plurality of the electrodes are positioned a distance from the chain of droplets.

An EUV source may include the system of the first embodiment. The EUV source may be part of an inspection system, such as for workpieces like semiconductor wafers or reticles.

A method is provided in a second embodiment. The method includes directing a liquid through a nozzle. The nozzle is configured to dispense a jet of the liquid. An electric field is generated using an electrode. The jet is directed into the electric field to form a chain of droplets. The liquid may be Xe, Sn, Li, Ar, or H₂O. In an instance, the liquid is liquid Xe.

The electrode may be a knife edge electrode, a needle electrode, or an annular electrode that defines an aperture through which the chain of droplets passes.

The distance may be from 10 μm to 1 mm. In an embodiment, the distance is approximately 100 μm.

The electric field may have a field strength from 1 kV/cm to 100 kV/cm.

The electric field may be generated using a plurality of the electrodes.

The method may include generating EUV radiation in an EUV source using the chain of droplets.

### DESCRIPTION OF THE DRAWINGS

For a fuller understanding of the nature and objects of the disclosure, reference should be made to the following detailed description taken in conjunction with the accompanying drawings, in which:

FIG. 1 is a cross-sectional block diagram of an embodiment of a system in accordance with the present disclosure;

FIG. 2 is a diagram showing the relationship of the electrode and the chain of droplets;

FIG. 3 is a cross-sectional block diagram of another embodiment of system in accordance with the present disclosure;

FIGS. 4A-4D are embodiments of electrodes in accordance with the present disclosure;

FIG. 5 is a flowchart of a method in accordance with the present disclosure;

FIG. 6 is an example when no electric field is applied, which results in an irregular chain of droplets;

FIG. 7 is an example when an electric field is applied, which results in the chain of droplets becoming more regular;

FIG. 8 is a schematic of PZT signal generation;

FIG. 9 illustrates examples of an IPA jet bunching effect preceding good coalescence obtained with an embodiment disclosed herein;

FIG. 10 illustrates various exemplary jets;

FIG. 11 illustrates an exemplary liquid xenon jet;

FIG. 12 is a chart showing measured PZT voltage for the example of FIG. 11;

FIG. 13 is a chart showing measured PZT current for the example of FIG. 11;

FIG. 14 is a chart showing Rayleigh-Plateau instability increment and spectrum of a square-wave with 65% duty cycle; and

FIG. 15 shows the two-mode coalescence effect.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

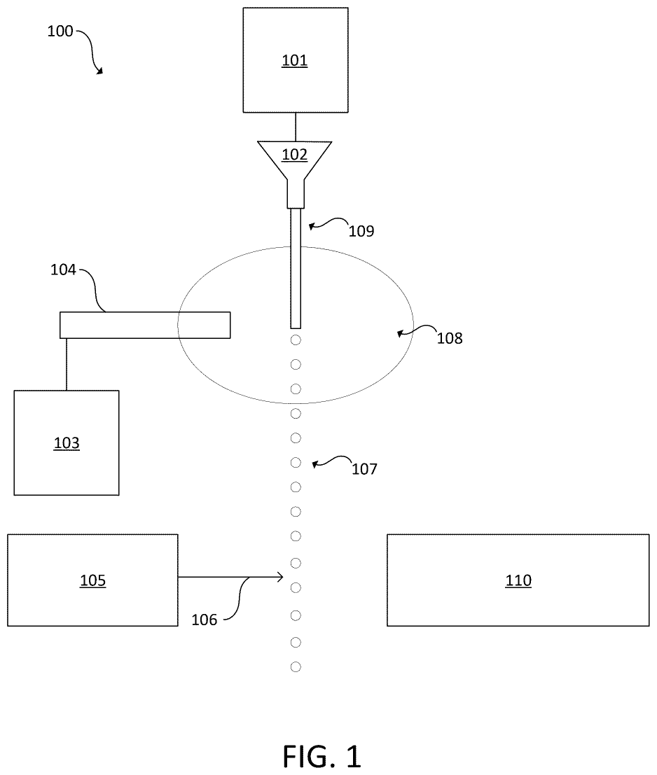

Embodiments disclosed herein break up a liquid jet of xenon or another material into a regular or otherwise patterned chain of droplets. The cryogenic xenon jet is induced to break into a regular chain of xenon droplets without introducing mechanical vibration and/or additional heat load to the nozzle. FIG. 1 is a cross-sectional block diagram of an embodiment of a system 100. The system includes a liquid source 101. The liquid source 101 includes a liquid, which may be Xe, Sn, Li, Ar, H₂O, or other materials. The liquid source 101 may provide cooling, heating, and/or pressurization to maintain the material in liquid form. The liquid source 101 is in fluid communication with a nozzle 102. The nozzle 102 can dispense a jet 109 of the liquid. The jet 109 and droplets 107 are formed from the liquid in the liquid source 101. The droplets 107 in the jet 109 attain their velocity due to a backing pressure at the nozzle and may be propelled by gravity or other mechanisms. The jet 109 velocities may vary from 1 m/s to 100 m/s, such as from 10 m/s to 30 m/s. The jet is not necessarily propelled by any applied force. The jet 109 leaves the nozzle 102 at a high velocity due to the high backing pressure and keeps moving at that velocity. The potential energy of the compressed fluid converts into the kinetic energy of the jet 109 at the opening of the nozzle 102 at the tip of the nozzle 102.

In an instance, the nozzle 102 is a capillary tube made of a material such as glass. The nozzle 102 may be pulled and snapped under high temperatures when the nozzle 102 is soft to form a narrow capillary opening, such as from 10 μm to 100 μm in diameter. In another instance, the nozzle 102 may be fabricated of a metal disc with an aperture, such as from 10 μm to 100 μm in diameter. Other dimensions are possible for the aperture in the nozzle 102.

A waveform generator 103 is electrically connected to an electrode 104. The electrode 104 is positioned a distance from the chain of droplets 107. The distance between the electrode 104 and the chain of droplets is non-zero. The electrode 104 is configured to generate an electric field 108 around the jet 109 and/or chain of droplets 107. The jet 109 may enter the electric field 108 to form the chain of droplets 107 or the jet 109 may pass through the electric field 108 to form the chain of droplets 107. The chain of droplets 107 are formed from material in the jet 109 and may begin to form prior to the jet 109 entering the electric field 108. Thus, the jet 109 may begin breaking into the chain of droplets 107 before reaching the electric field 108, in the electric field 108, or after passing through the electric field 108. The electric field 108 may vary in time and may be external. The waveform used to generate the electric field 108 may have a periodic shape or non-periodic shape. In an instance, the electric field 108 is an AC electric field.

In an instance, the waveform generator 103 includes an arbitrary function waveform generator and a high bandwidth voltage amplifier. The function generator can output voltage shaped in time as specified by a user. For example, a sinusoidal voltage may be used, but other waveforms like a square-wave, saw-tooth, pulsed, or arbitrary periodic shape also may be used. The voltage amplifier can have high bandwidth that enables amplification without distortion signals that have a complex shape in time. In an example, the bandwidth of the amplifier may be 1 MHz and the output gain may be 20. The amplitude of the sinusoid may be up to +/−100 V. The function generator typically outputs up to +/−5 V up to 20 MHz. Other parameters for the generators and amplifiers are possible, such as those with higher parameters. The dielectric strength of xenon or other surrounding gas may be considered when selecting parameters of the waveform generator 103. When certain voltage is exceeded, there can be a spark at the electrode 104.

The operation of the electrode 104 is based on the dielectrophoretic effect. While the chain of droplets 107 (e.g., liquid xenon) is electrically non-conductive, it has a certain polarizability. Polarizability also may be referred to as electric susceptibility, which is χ=ϵ−1, where e is the dielectric permittivity of a material. The electric field 108 applied to a non-conductive chain of droplets 107 induces polarization within material of the droplets 107. The polarized chain of droplets 107 then senses the electric field 108 gradient and is attracted toward a greater magnitude of the electric field 108. Thus, the chain of droplets 107 is attracted toward the electrode 104. The attraction force causes bulging or varicosity in the jet 109 with a period depending on velocity of the jet 109 and the frequency of the electric field 108. Given that the electrophoretic attraction force magnitude exceeds the natural thermal fluctuations in the surface of the jet 109, the electric field excitation is amplified further by the Rayleigh-Plateau instability, which naturally occurs in all liquid jets, until the jet 109 ultimately breaks apart into a series of equidistant droplets 107 or droplets 107 with another spatial pattern. Thus, the chain of droplets 107 is formed from the jet 109. The pattern of the droplets 107 is different from that of the jet 109. This pattern may have, for example, a regular spacing. The pattern of the droplets 107 may depend on the electric field 108 as a function of time. The electric field 108 that is applied may depend on the shape of the electrode 104.

The pattern of the droplets 107 may coalescence using an embodiment disclosed herein, which means that multiple small droplets 107 form a bigger droplet 107. The bigger droplets may also form a regular chain that are be more spaced out. Another pattern is a bigger droplet 107 followed by a smaller droplet 107 in a repeating sequence. Another pattern is bunching of small droplets. A few small droplets 107 come close together in a line, then there is a gap, and then another group of small droplets 107 come close together in a line. This pattern with the group of small droplets 107 can repeat. These patterns can be achieved by changing the shape of the excitation voltage in time or mixing the vibration modes in a single waveform.

In an embodiment, the distance between an edge of the electrode 104 facing the chain of droplets 107 and the droplets 107 is approximately 100 μm. The distance between an edge of the electrode 104 facing the chain of droplets 107 and the droplets 107 may be from 10 μm to 1 mm. The distance may depend on the jet diameter, jet velocity, and/or fluid dielectric constant.

The electric field 108 can have a field strength from 1 kV/cm to 100 kV/cm or breakdown limit, whichever is greater. Breakdown can happen at around 30 kV/cm in air. In vacuum, breakdown may occur at up to 100 kV/cm. The electric field 108 may have a frequency from 1 kHz to 1 MHz depending on the size of the droplets 107. For a small jet 109 diameter, such as 10 μm, a frequency of 300 kHz may be used. For bigger jet 109 diameters, the frequency can be as low as 3 kHz.

In an embodiment, the system 100 is part of an EUV source with a laser source 105 that generates a laser 106 projected through the droplets 107. This can generate a plasma that emits EUV radiation. This EUV radiation can be used to inspect a workpiece, such as a semiconductor wafer, in an inspection system. The workpiece can be positioned on a stage in a path of the EUV radiation. Various optical components can be positioned along the path of the EUV radiation. A beamline 110 of an inspection system is shown in FIG. 1. However, the system 100 can be used in other systems than an inspection system or an EUV source.

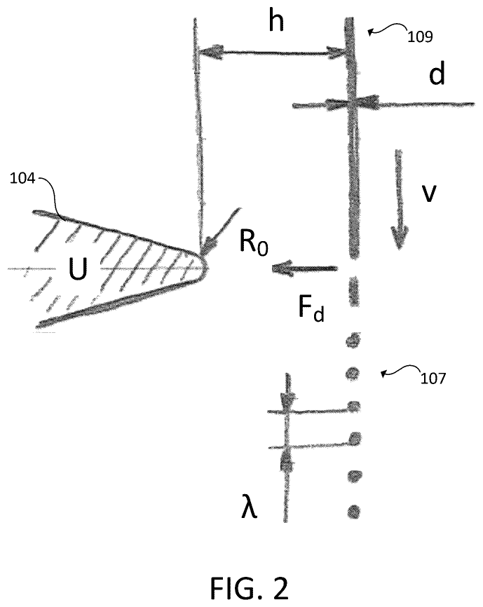

FIG. 2 is a diagram showing the relationship of the electrode 104 and the chain of droplets 107. In FIG. 2, d is the jet 109 diameter (i.e., the nozzle aperture diameter), which ranges from 1 μm to 100 μm and more. A typical jet 109 diameter is from 30 μm to 50 μm. h is the distance between the tip of the electrode 104 and the jet 109, which may be from 10 μm to 1 mm (e.g., 100 μm to 300 μm). v is jet 109 velocity, which may be from 1 m/s to 100 m/s (e.g., between 10 and 30 m/s). r₀ is the curvature radius of the tip of the electrode 104 (e.g., sharpness), which may be from 1 μm to 100 μm. Fa is the dielectrophoretic force (e.g., 10⁻⁹ N or more). λ is the separation of droplets 107 (e.g., from 50 μm to 1 mm). U is the magnitude of voltage (e.g., from 10 V to 1000 V).

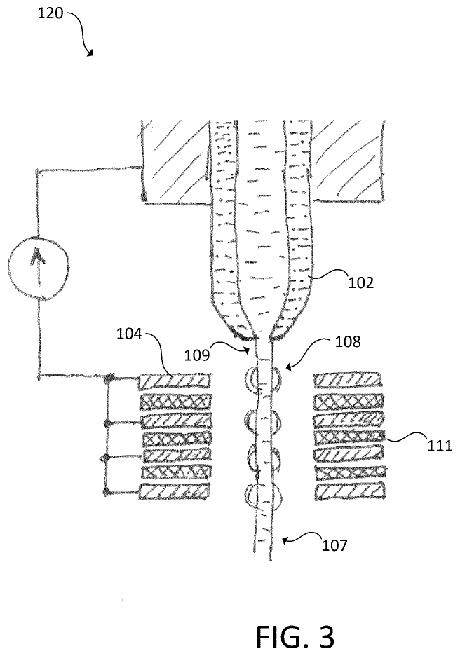

FIG. 3 is a cross-sectional block diagram of another embodiment of system 120. In this system, a plurality of electrodes 104 are used. While it is possible to have electrodes 104 on only one side of the jet 109 or chain of droplets 107, the electrodes 104 in FIG. 3 are positioned on both sides of the jet 109 or chain of droplets 107. These electrodes 104 may be pairs of electrodes 104 like those shown in FIG. 1, may have an annular shape, or may have other shapes. In this example, A is 1 mm and the magnitude of voltage is from 10 V to 100 V.

The system 120 also may optionally include insulators 111 between each pair of electrodes 104. In this embodiment, the jet 109 or chain of droplets 107 enters or passes through the electrodes 104 and the insulators 111. The insulators 111 may have the same shape as the electrodes 104 or may have different shapes. In an instance, the insulators 111 are ceramic discs. The ceramic may be alumina or any other non-conductive material, like a plastic (e.g., HDPE, PEEK, PTFE, etc.).

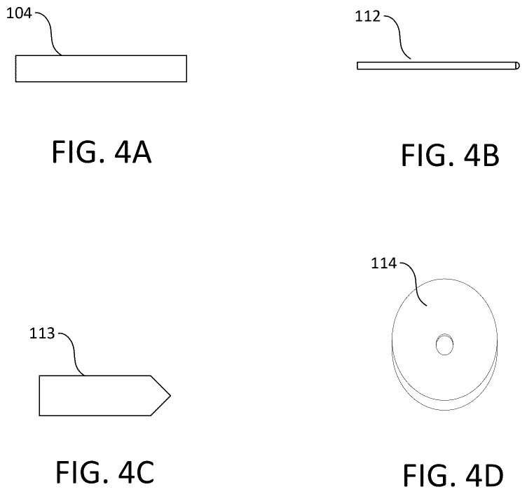

FIGS. 4A-4D are embodiments of electrodes 104, which can be used in the system 100. The electrode 104 in FIG. 4B is a rectangular or plate design. The electrode 112 in FIG. 4B is a needle-tip electrode. The electrode 113 in FIG. 4C is a knife-edge electrode. The electrode 114 in FIG. 4D is an annular disc with an aperture that the jet or chain of droplets enters or passes through. Adjacent electrodes 114 may have different electric potential. The needle-tip electrode 112 or the knife-edge electrode 113 can optionally have a counterweight electrode positioned opposite to the needle-tip or knife-edge across the jet 109 or chain of droplets 107. The counterweight electrode can be a needle-tip, a knife-edge, or a flat plate that mirrors the charge of the needle-tip or knife-edge of the main electrode. The shape of the electrodes disclosed herein may be shaped to not be sharp enough as to cause an electrical breakdown in surrounding gas around the jet 109 or droplets 107. The electrodes 104 may have thicknesses from 10 μm to 1 mm. Smaller or larger thicknesses are possible depending on other parameters, such as diameter or velocity of the jet 109.

The electrodes 104 in FIGS. 4A-4D can be fabricated of stainless steel, another metal, or another conductor. The electrodes 104 also can be fabricated of a semiconductor like silicon or carbon.

One or more of each of the electrodes in FIGS. 4A-4D may be used. Combinations of the same electrodes or different types of electrodes may be used. Other designs are possible than those illustrated herein.

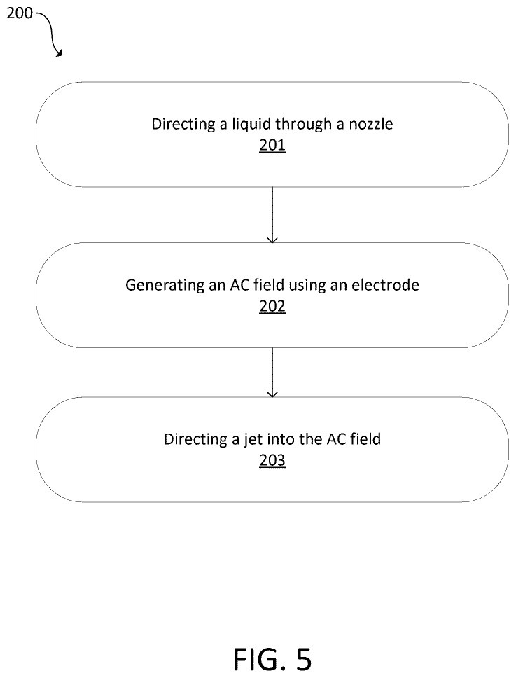

FIG. 5 is a flowchart of a method 200. The method may use an embodiment of the system 100. At 201, a liquid is directed through a nozzle, such as the nozzle 102, to form a jet. An electric field is generated at 202. For example, the electric field 108 may be generated using an electrode 104. The jet, such as the jet 109 in FIG. 1, is directed into the electric field at 203. This forms chain of droplets, such as the chain of droplets 107 in FIG. 1. The chain of droplets 107 may have a regular spacing and/or size. The liquid may be Xe, Sn, Li, Ar, H₂O, or other materials. EUV radiation may be generated using the chain of droplets in an EUV source, a broadband source, a vacuum ultraviolet (VUV) source, or another radiation source.

The electric-field induced jet excitation and breakup may be better defined mathematically than a piezo-transducer vibration method, which provides greater predictability because the field can be predicted and the jet response can be modelled. It also makes the system easier to design and the performance easier to qualify. In an instance, the electric field induced jet breakup technique described herein does not mix in any higher harmonics into the jet modulation effect when compared to the piezo-transducer vibration. Embodiments disclosed herein also do not introduce any additional heat to the nozzle. Such additional heat can compromise xenon liquid phase continuity or the continuity of other droplets.

The surface tension energy in multiple droplets is lower than that in a solid jet which is why jets tend to release excess surface tension energy and break up into smaller pieces. This means that any initial varicosity on the jet will amplify due to the action of its own surface tension forces, which is referred to as Rayleigh-Plateau instability. When an external disturbance is introduced at a frequency that is close to the fundamental instability mode, the jet will break up into a regular chain of droplets.

While disclosed with xenon in examples, the embodiments disclosed herein can be used with tin. With tin, an effect of the system 100 may be based on the direct electrostatic force action rather than medium polarization. A magnetic force also may be used for the field. With the dielectric jet, electric voltage is applied between the ground and the electrode. The potential of the jet is undefined or unknown (e.g., “floating”) because it is not electrically connected. The electrode produces the surrounding electric field that can be perceived by the jet. In the case of a conductive jet, the voltage can be applied between the electrode and the jet directly. The jet also generates its own electric field, and interacts with the electrode. That way, the jet potential is defined and known. The jet is typically grounded. Although jet's potential is zero, it can represent yet another electrode itself and the interaction force may be stronger. A conductive jet can also be excited magnetically. Because the jet is moving, applying an external magnetic field to the jet will generate tiny eddy currents in the jet due the Faraday's law of inductance. Thus, the electrically-conductive jet will be locally slowed down when the magnetic field is at its higher value. That way, bulging on the jet can be produced by slowing the jet down locally at a high frequency. In another embodiment, the magnetic properties of liquefied gases may be used. For example, liquid oxygen is paramagnetic. That means the jet may be directly attracted by magnetic field for a paramagnetic liquid. Other liquids may be diamagnetic. Any magnetic properties may be used in this embodiment.

In an embodiment, such as with for conductive jets, the electric potential can be applied to the jet itself to enhance the electrostatic attraction force effect. Thus, voltage is applied between the electrode and the jet rather directly instead of applying voltage between the electrode and laboratory ground in the case of dielectric jets.

The following examples are meant to be illustrative. These examples are not intended to be limiting.

### Example 1

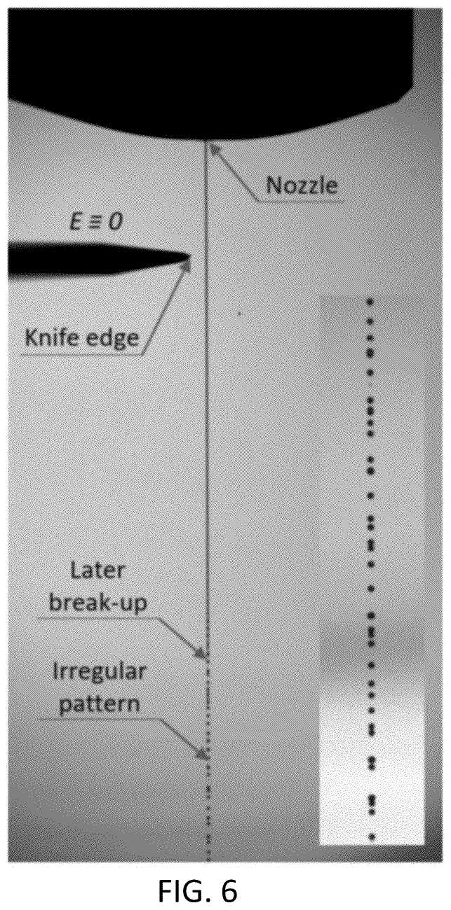

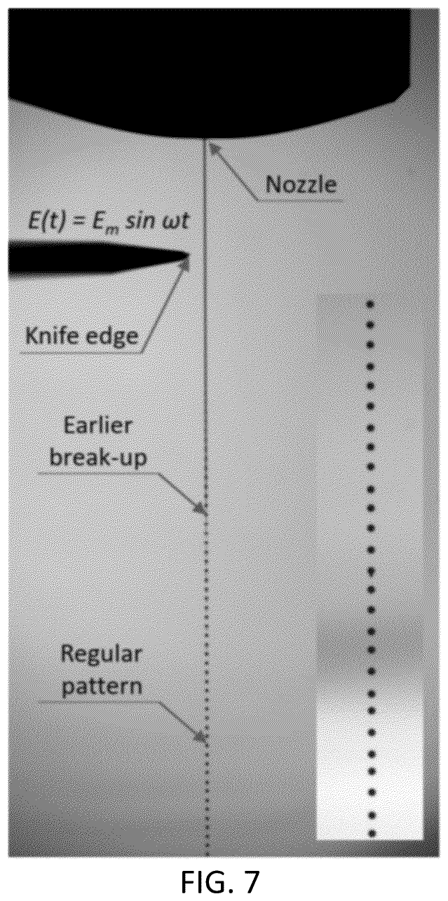

FIG. 6 is an example when no electric field is applied, which results in an irregular chain of droplets. FIG. 7 is an example when an electric field is applied, which results in the chain of droplets becoming more regular. In the example illustrated in FIGS. 6 and 7, a 40 μm glass nozzle was used. A knife edge electrode was placed approximately 100 μm away from a jet of isopropyl alcohol (IPA). An alternating voltage of +/−200 V was applied to the knife edge electrode at approximately 130-150 kHz. This produced alternating electric field with a substantial gradient due to the knife-edge electrode's sharp, abrupt geometry. The corresponding electric field strength at the knife edge was estimated to be approximately 10 kV/cm. The electric field induced jet medium polarization. Once polarized, the jet was attracted towards the knife edge by the dielectrophoretic force. A dielectrophoretic force occurs when an electric dipole is placed within a non-uniform electric field. The jet was bulging periodically and ultimately broke up in a regular droplet chain pattern that is shown in FIG. 7.

### Example 2

Force was calculated for a liquid xenon jet. The Rayleigh Plateau instability is initially seeded by the natural thermal fluctuations of a liquid xenon jet. For the jet excitation via dielectrophoretic force to be effective, the dielectrophoretic force exceeds the thermal fluctuations. In this example, the parameters are r0≈100 μm knife edge or needle tip radius, h≈100 μm distance between the knife edge and the liquid xenon jet, U≈100 V magnitude of the AC voltage applied to knife edge, χ≈0.8 polarizability of liquid xenon, T≈200 K temperature of liquid xenon, σ=20 mN/m surface tension of liquid xenon at ~200 K, Ebr≈25 T kVcm xenon breakdown electric field strength at atmospheric pressure, and Vd≈10-10 liquid xenon droplet volume. These parameters refer to variables in FIG. 2 and later equations in this example. An estimate of the surface tension force magnitude due to thermal fluctuations is \sqrt{kTσ}≈10⁻¹²N. Thus, the peak dielectrophoretic force can be estimated to be FD≈10⁻⁹N, which is greater than the fluctuations. The maximum electric field at the tip will be Eₘₐₓ=U/r₀≈ 10 kV/cm≤25 kV/cm≈E_{br}. Consequently, the dielectrophoretic force can be used to seed the Rayleigh Plateau instability.

To optimize the dielectrophoretic force, the function F_{D}(r₀)=2χε₀U²r₀²/(r₀+h)⁵, which peaks at r₀=2 h/3, may be used. Thus, the following equation applies.

$${F}_{max} = \frac{216}{3 \; 125} \frac{{χε}_{0} {U}^{2}}{{h}^{3}}$$

For the dielectrophoretic effect to be strong enough, the following equation will apply.

$${F}_{max} ≫ \sqrt{kT σ}$$

In terms of h, this means the following equation applies.

$$h ≪ \sqrt[3]{\frac{216}{3 \; 125} \frac{{χε}_{0} {U}^{2} {V}_{d}}{\sqrt{kT σ}}} \approx 600 - 1000 μm$$

Within a range of voltages,

$$h ≪ \sqrt[3]{{V}_{d}} or h \approx \sqrt[3]{{V}_{d}} \approx 70 μm .$$

### Example 3

In the embodiments disclosed herein, mixing occurs using only the two modes that act on the jet. This includes the fundamental Rayleigh-Plateau mode ω0 and the lower frequency coalescence mode ω2=ω0/N, where N is an integer. The coalescence regime can be further improved by adjusting the phase shift between the two modes. The fundamental Rayleigh-Plateau mode excites the most prominent jet break-up mode that leads to effective natural suppression of any other less potent modes. The lower frequency coalescence mode, being superimposed, introduces a periodic pattern of droplets spatial period shrinking and expansion, which results in droplets coalescing further downstream. Unlike the square wave method, any unnecessary higher harmonics are not contained in the PZT signal. This technique offers a better-defined procedure for droplet coalescence that relates to the hydrodynamics instability. This makes finding a good coalescence regime easier and faster in a wide range of jetting parameters.

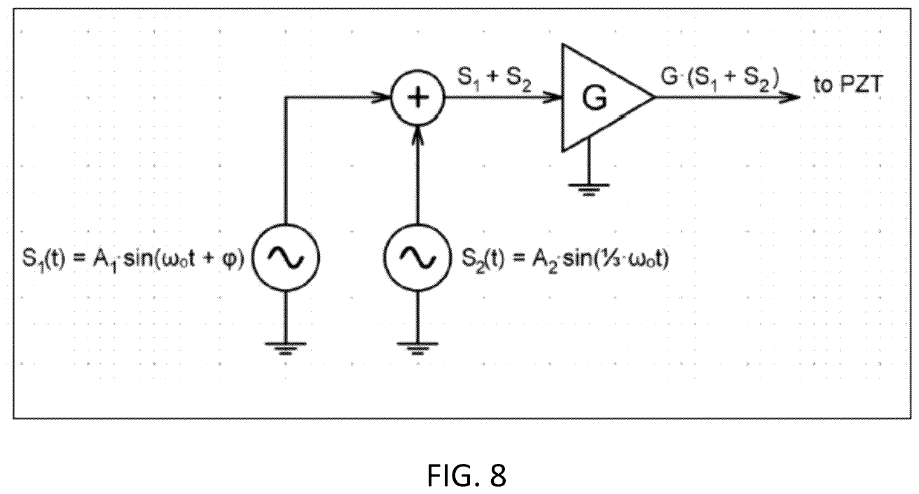

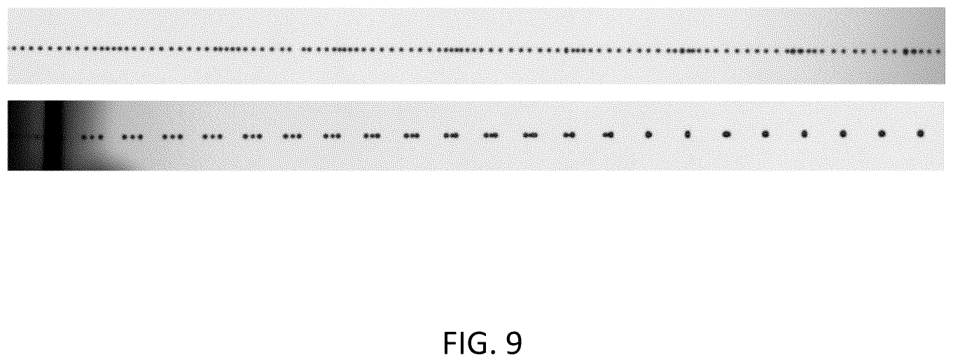

FIG. 8 is a schematic of PZT signal generation using an embodiment disclosed herein. Two signals S1 and S2 are added in a summation amplifier (or are processed digitally) and are fed into a high bandwidth amplifier with gain G. The resulting alternating high voltage is fed into the piezo transducer or the electrode. FIG. 9 illustrates examples of an IPA jet bunching effect preceding good coalescence obtained with an embodiment disclosed herein.

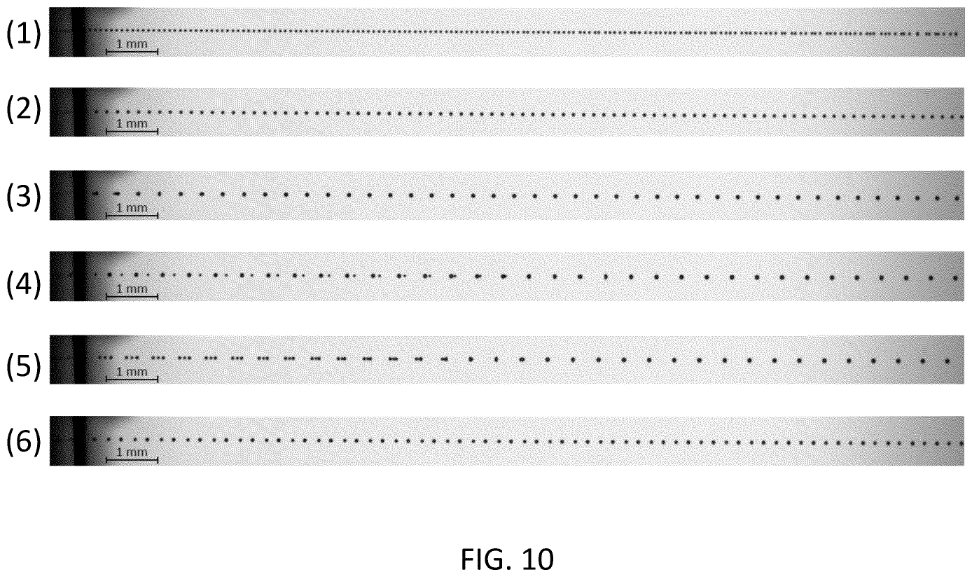

Combinational modes and half-integer modes also work, which is shown in FIG. 10. In all the examples of FIG. 10, the nozzle inner diameter is 30 μm with an IPA velocity of 17.47 m/s. Each example includes a fundamental mode of 160 kHz. Example (1) shows a fundamental mode of 160 kHz. Example (2) shows the fundamental mode with a coalescence mode of 80 kHz and a frequency ratio of 2. Example (3) shows the fundamental mode with a coalescence mode of 40 kHz and a frequency ratio of 5. Example (4) shows the fundamental mode with a coalescence mode of 32 kHz and a frequency ratio of 5. Example (5) shows the fundamental mode with a second mode of 96 kHz. The combinational mode is 0.5*(160-96)=32 kHz and a ratio of 5. Example (6) shows the fundamental mode with a coalescence mode of 64 kHz and a frequency ratio of 2.5.

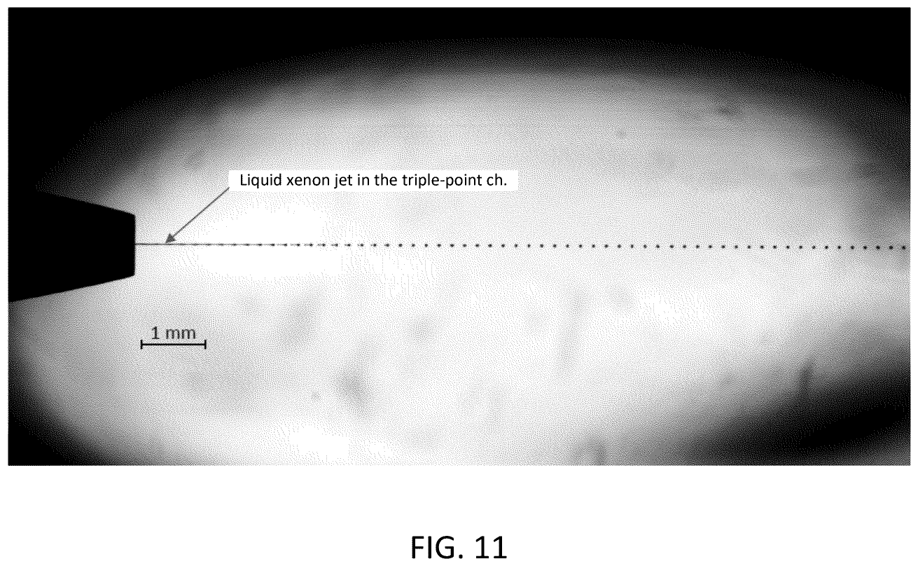

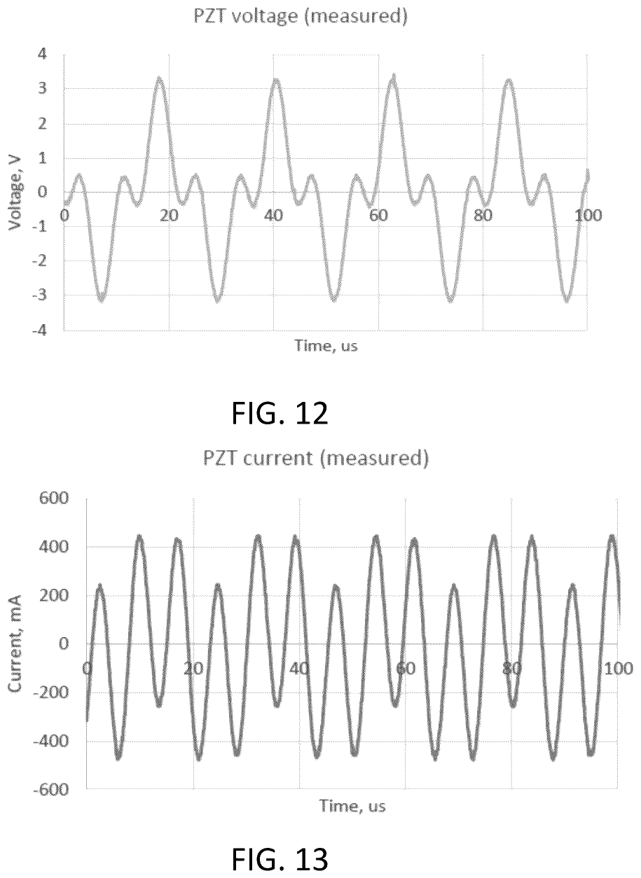

FIG. 11 illustrates an exemplary liquid xenon jet. The techniques disclosed herein works as well with liquid xenon as with IPA. In FIG. 11, the nozzle inner diameter is 32 μm with a fundamental mode of 150 kHz and a coalescence mode of 50 kHz. Consistent droplet coalescence was demonstrated through a two-hour run. It was easy to restore a good droplet chain if the regime parameters drifted. FIG. 12 is a chart showing measured PZT voltage for the example of FIG. 11. FIG. 13 is a chart showing measured PZT current for the example of FIG. 11.

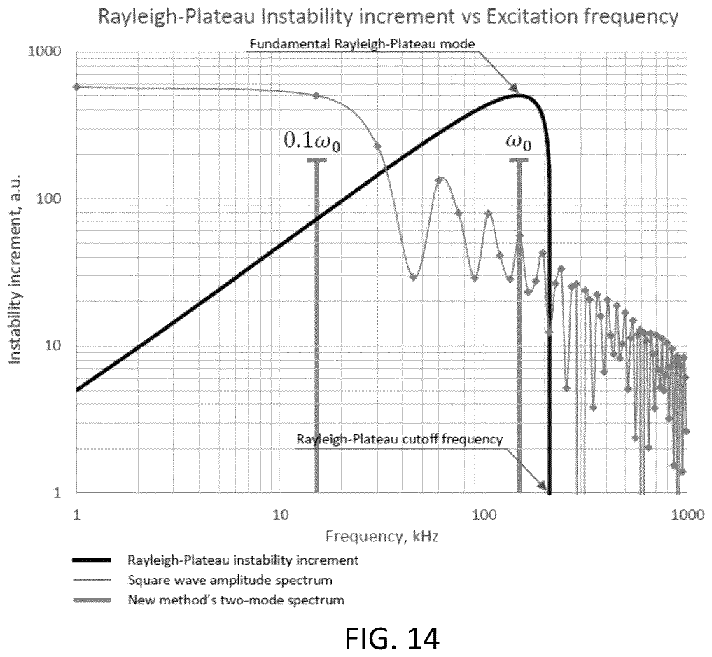

The Rayleigh-Plateau instability spectrum was evaluated for a jet dispensed from a 30 μm nozzle at 25 m/s. FIG. 14 is a chart showing Rayleigh-Plateau instability increment and spectrum of a square-wave with 65% duty cycle. The fundamental Rayleigh-Plateau frequency for such jet is f₀≈150 kHz. The cutoff frequency when the jet becomes indifferent to the external excitation is f_{cutoff}≈210 kHz. Note how the amplitude spectrum of a 15 kHz square wave with 65% duty cycle has many harmonics within the Rayleigh-Plateau instability perceptible frequency range. Having multiple harmonics in the jet excitation signal introduces uncertainty in the Rayleigh-Plateau instability behavior. Using the embodiments disclosed herein, only two essential frequencies are used and the spectrum is free from parasitic harmonics. Good coalescence with the harmonics ratio 2≤N≤10 was observed with the higher harmonic being close to the fundamental instability mode. This result was demonstrated on both IPA and xenon droplets.

FIG. 14 notes the “Fundamental Rayleigh-Plateau mode,” which represents the theoretical instability increment. This curve shows how fast a jet can spontaneously break up into droplets at a particular frequency (i.e., wavelength). There is a prominent frequency on the curve that is referred to as the fundamental instability mode.

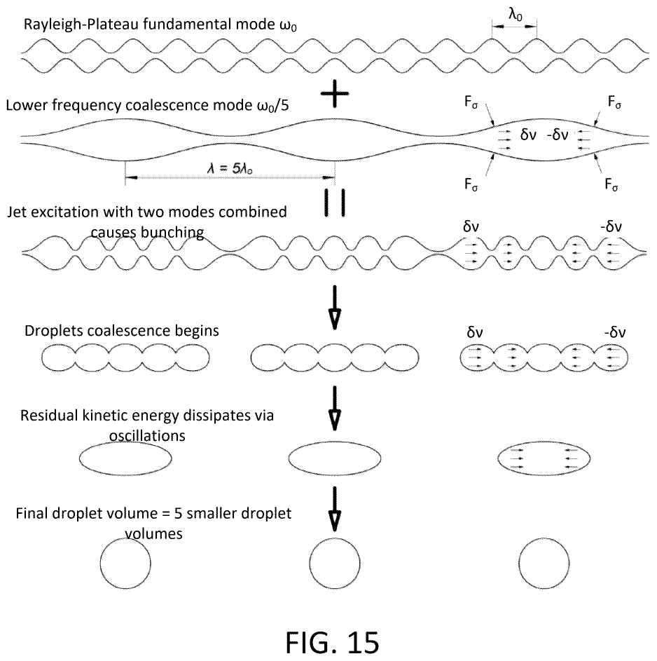

FIG. 15 shows the two-mode coalescence effect. The fundamental Rayleigh-Plateau mode introduces the strongest high frequency excitation, which forms a distinct regular pattern on the jet. All other spontaneous modes are suppressed. The lower frequency mode introduced by the piezo transducer is unstable as well, which means it tends to move towards forming larger droplets. However, its increment is smaller and it may not be able to compete with all other potential modes alone. When two modes work together, the fundamental mode provides a jet with a regular pattern that is free from other irrelevant modes. The lower frequency mode introduces a small velocity increment to the fundamental frequency droplets. The small droplets move towards the antinodes of the longer mode and ultimately combine into one bigger droplet. The residual potential energy is released and dissipated throughout the final droplet capillary-wave oscillations due to finite fluid viscosity.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
a liquid source that includes a liquid;
a nozzle in liquid communication with the liquid source, wherein the nozzle is configured to dispense a jet of the liquid;
a waveform generator; and
an electrode positioned a distance from the jet of the liquid, wherein the electrode is electrically connected with the waveform generator, wherein the electrode is configured to generate an electric field that the jet enters to form a chain of droplets.

2. The system of claim 1, wherein the electrode is a knife edge electrode or a needle electrode.

3. The system of claim 1, wherein the electrode is an annular electrode that defines an aperture, and wherein the jet enters the aperture.

4. The system of claim 1, wherein the liquid is Xe, Sn, Li, Ar, or H₂O.

5. The system of claim 4, wherein the liquid is Xe.

6. The system of claim 1, wherein the distance is from 10 μm to 1 mm.

7. The system of claim 6, wherein the distance is approximately 100 μm.

8. The system of claim 1, wherein the electric field has a field strength from 1 kV/cm to 100 kV/cm.

9. The system of claim 1, further comprising a plurality of the electrodes positioned a distance from the chain of droplets.

10. An EUV source that includes the system of claim 1.

11. An inspection system that includes the EUV source of claim 10.

12. A method comprising:
directing a liquid through a nozzle, wherein the nozzle is configured to dispense a jet of the liquid;
generating an electric field using an electrode; and
directing the jet into the electric field to form a chain of droplets.

13. The method of claim 12, wherein the electrode is a knife edge electrode or a needle electrode.

14. The method of claim 12, wherein the electrode is an annular electrode that defines an aperture, and wherein the jet enters the aperture.

15. The method of claim 12, wherein the liquid is Xe, Sn, Li, Ar, or H₂O.

16. The method of claim 15, wherein the liquid is Xe.

17. The method of claim 12, wherein the distance is from 10 μm to 1 mm.

18. The method of claim 12, wherein the electric field has a field strength from 1 kV/cm to 100 kV/cm.

19. The method of claim 12, wherein the electric field is generated using a plurality of the electrodes.

20. The method of claim 12, further comprising generating EUV radiation in an EUV source using the chain of droplets.
